(19) United States
(12) Patent Application Publication
(10) Pub. No.: US 2013/0086422 A1
(43) Pub. Date: Apr. 4, 2013

(54) READ/WRITE TEST METHOD FOR HANDHELD ELECTRONIC PRODUCT

(71) Applicants: Chun-Lin HUANG, Taipei City (TW); Ching-Feng HSIEH, Taipei City (TW)

(72) Inventors: Chun-Lin HUANG, Taipei City (TW); Ching-Feng HSIEH, Taipei City (TW)

(73) Assignees: ASKEY COMPUTER CORP.; ASKEY TECHNOLOGY (JIANGSU) LTD.

(21) Appl. No.: 13/286,254

(22) Filed: Nov. 1, 2011

(30) Foreign Application Priority Data
Sep. 30, 2011 (TW) 100135595

(51) Int. Cl. G06F 11/28

(52) U.S. Cl. 714/32; 714/E11.178

(57) ABSTRACT

A read/write test method for handheld electronic product is introduced. The handheld electronic product is connected to a storage device and is equipped with an open platform having a data read/write test program installed thereon. In the read/write test method, the following steps are repeatedly executed according to a default test condition: the data read/write test program sends out a first test command to write a test data file into the storage device; the data read/write test program sends out a second test command to execute closing, opening and reading of the test data file; and the data read/write test program, upon confirmation of successful reading of the test data file, sends out a third test command to execute cutting, pasting, copying, and deleting of the test data file. Upon completion of the above steps, test results from each of the steps are output for a test operator to analyze.

### CROSS-REFERENCE TO RELATED APPLICATION

This non-provisional application claims priority under 35 U.S.C. §119(a) on Patent Application No(s).100135595 filed in Taiwan, R.O.C. on Sep. 30, 2011, the entire contents of which are hereby incorporated by reference.

### FIELD OF TECHNOLOGY

The present invention relates to a test method, and more particularly to a read/write test method for handheld electronic product.

### BACKGROUND

Presently, more and more handheld electronic products equipped with an open platform have been introduced into the market. To ensure the operational stability of these handheld electronic products, the manufacturers would perform relevant stability tests for them before delivery. Among others, the data read/write test is to ensure the transmission stability between the handheld electronic product and a storage device.

In a conventional test environment, the handheld electronic product is subjected to repeated data read/write stress test for predetermined number of times and predetermined duration. To save the manpower or to increase the production efficiency, the test duration and test times are often reduced in order to simplify the process of the stress test. However, insufficient test duration and times fails to effectively ensure a highly reliable and stable control of the data read/write between the tested handheld electronic product and storage device.

Moreover, during the process of stress test, there are chances the test operator on the test production line fails to correctly determine whether the test data has been completely read from or written into the storage device. And, due to the imperfect data read/write action, it is not able to effectively determine whether the read/write problem is caused by the handheld electronic product or the storage device. That is, such a vague and inaccurate determination would largely reduce the reliability of the test results.

It is therefore tried by the inventor to develop an improved read/write test method for handheld electronic product, so as to solve the problems in the conventional test method.

### SUMMARY

A primary object of the present invention is to provide a read/write test method for handheld electronic product, so as to test the data read/write control between a handheld electronic product and a storage device through repeated stress tests for preset duration and number of times.

To achieve the above and other objects, the read/write test method for handheld electronic product according to the present invention is used with a handheld electronic product, which is connected to a storage device and is equipped with an open platform having a data read/write test program installed thereon. The read/write test method includes a step (a) in which a default test condition is defined; a step (b) in which the data read/write test program sends out a first test command to write a test data file into the storage device; a step (c) in which the data read/write test program sends out a second test command upon confirmation of the presence of the test data file in the storage device, so as to execute closing and opening of the test data file and to read the test data file; a step (d) in which the data read/write test program sends out a third test command upon confirmation of successful reading of the test data file, so as to sequentially execute control of cutting, pasting, copying and deleting of the test data file; and a step (e) in which the steps (b) to (d) are repeated according to the default test condition, and test results from the steps (b) to (d) in each test are recorded, and final test results are output when the default test condition has been reached.

Compared with the prior art, the read/write test method for handheld electronic product according to the present invention utilizes the data read/write test program installed on the handheld electronic product to send out multiple test commands, so as to execute control of different items related to the data read/write between the storage device and the handheld electronic product. The test is repeated until the default test condition, such as a preset duration or a preset number of times, has been reached, and test results about the reading/writing of data by the handheld electronic product from/into the storage device are obtained and output for analysis.

### BRIEF DESCRIPTION

The structure and the technical means adopted by the present invention to achieve the above and other objects can be best understood by referring to the following detailed description of the preferred embodiments and the accompanying drawings, wherein

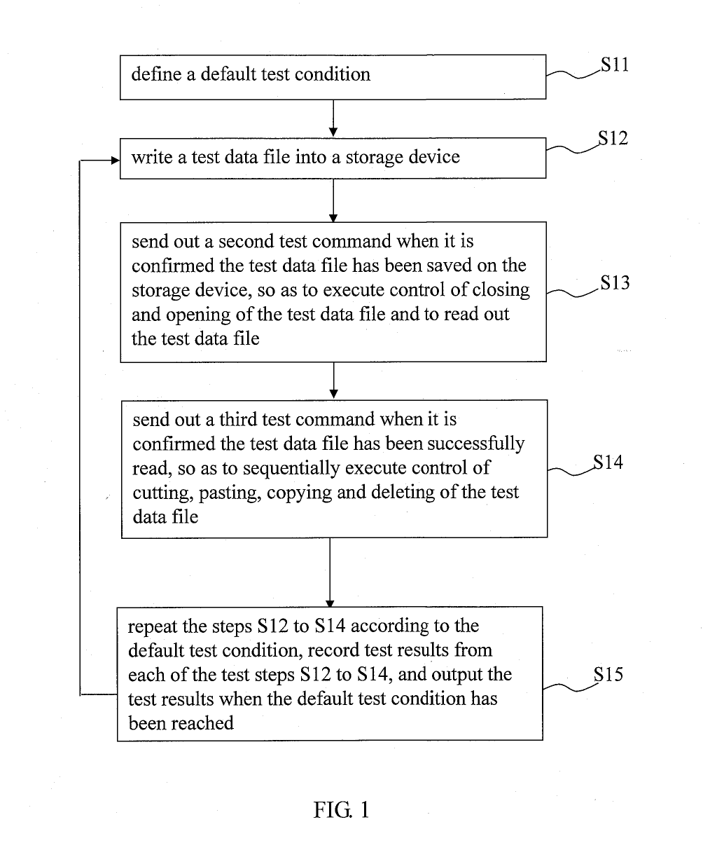

FIG. 1 is a flowchart showing the steps included in a read/write test method for handheld electronic product according to a first embodiment of the present invention; and

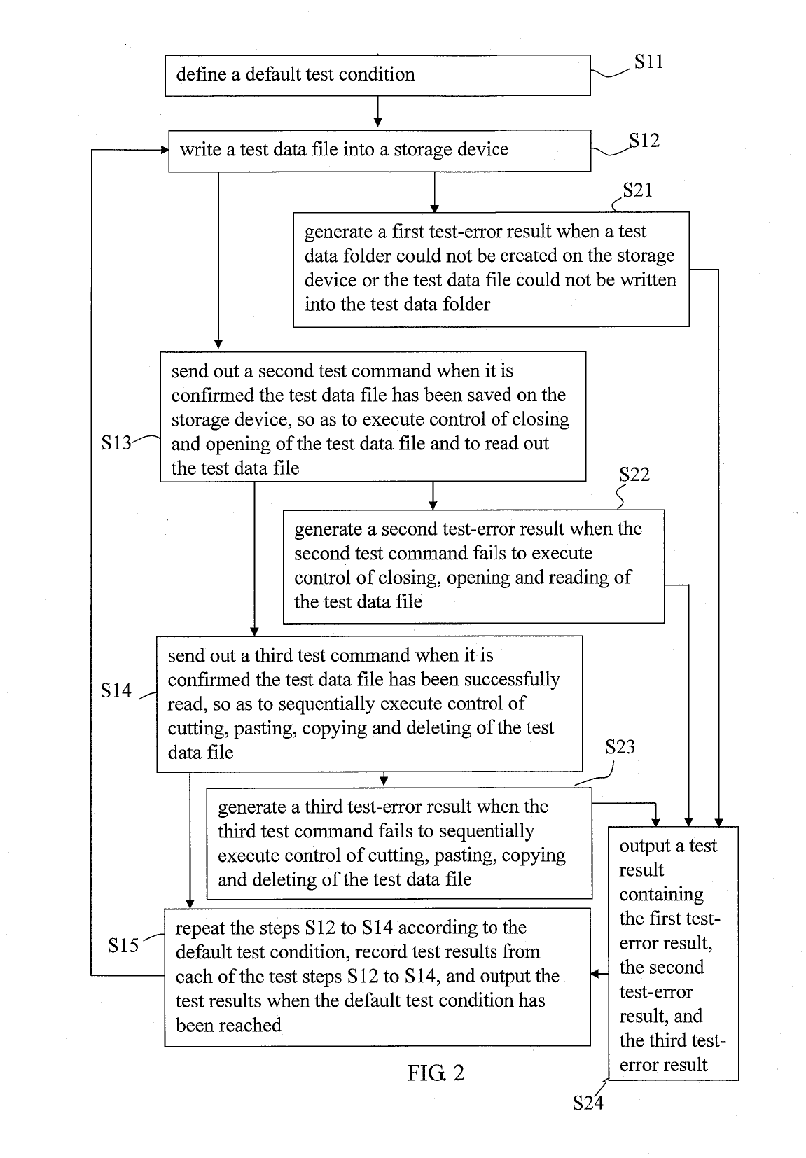

FIG. 2 is a flowchart showing the steps included in a read/write test method for handheld electronic product according to a second embodiment of the present invention.

### DETAILED DESCRIPTION

The present invention will now be described with some preferred embodiments thereof and with reference to the accompanying drawings.

Please refer to FIG. 1 that is a flowchart showing the steps included in a read/write test method for handheld electronic product according to a first embodiment of the present invention. In the illustrated first embodiment, the handheld electronic product is equipped with an open platform, such as the Android platform, on which a data read/write test program is installed. In addition, the handheld electronic product is connected to a storage device via a memory card slot provided on the handheld electronic product, and it is the memory card slot that is to be tested. The storage device includes a memory card slot to be tested and a memory card, which may be, for example, an SD card. The memory card slot to be tested is used to receive the memory card and control the memory card to do data transmission, such as data read/write.

In a first step S11 of the read/write test method according to the first embodiment of the present invention, a default test condition, such as a preset duration or number times, is defined for controlling the test. That is, the default test condition may include a preset duration or a preset number of times for the read/write test.

Then, in a step S12, cause the data read/write test program to send a first test command to the storage device, so that a test data file is written into the storage device. According to another embodiment, the step S12 may further include the creation of a test data folder in the storage device, so that the test data file is written into the test data folder. In the case of an SD card storage device, upon receipt of the first test command, the memory card slot to be tested writes the test data file into the SD card. Or alternatively, the memory card slot may create the test data folder first, so that the test data file is written into the test data folder in the SD card. That is, after the test data folder is successfully created, the test data file is then written into the test data folder. According to an embodiment of the present invention, the test data folder and the test data file are created as a tree structure for the file structure arrangement thereof and the test data files is created in the test data folder.

In the event the test data folder could not be created in the storage device or the test data file could be written into the test data folder in the step S12, the method goes to a step S21, in which a first test-error result is generated when it is confirmed the test data folder could not be created in the storage device or the test data file could not be written into the test data folder, and the first test-error result or a test result containing the first test-error result is output, as shown in FIG. 2. That is, the first test-error result is defined as a state, in which the first test command is executed but it is not able to create a test data folder or write a test data file into a test data folder.

In addition, the failure in creating the test data folder and writing the test data file into the test data folder might be caused by other reasons, such as, for example, an empty storage device without a memory card inserted therein, a damaged handheld electronic product, or a damaged storage device.

Then, in a step S13, when it is confirmed the test data file is present in the storage device, the data read/write test program sends a second test command to the storage device to execute control of closing and opening of the test data file, and to read in the test data file.

The following description is still based on the above SD storage device. When the first test command sent in the step S12 has been executed at the memory card slot to be tested, a second test command is further sent to the memory card slot to execute control of closing and opening of the test data file and to read data from the test data file and/or from the test data file in the test data folder after the test data file has been opened.

In the event the second test command could not execute control of closing, opening and reading of the test data file in the step S13, the method goes to a step S22, in which a second test-error result is generated when it is confirmed the second test command fails to execute control of closing, opening or reading of the test data file, and the second test-error result or a test result containing the second test-error result is output, as shown in FIG. 2. That is, the second test-error result is defined as a state, in which the second test command is executed but it is not able to close or open or read the test data file.

Then, in a step S14, when it is confirmed the test data file has been successfully read, the data read/write test program sends out a third test command to sequentially execute control of cutting, pasting, copying and deleting of the test data file.

The following description is still based on the above SD storage device. When the second test command sent in the step S13 has been executed at the memory card slot to be tested, a third test command is further sent to the memory card slot. The third test command first cuts the test data file in the test data folder, and then pastes the cut test data file to the test data folder; and then copies the test data file to form two test data files; and finally, deletes the two test data files so that the storage device returns to its initial state and does not have any test data folder and/or test data file present therein.

In the event the third test command fails to sequentially cut, paste, copy and delete the test data file, the method goes to a step S23, in which a third test-error result is generated or a test result containing the third test-error result is output when it is confirmed the third test command fails to execute control of cutting, pasting, copying and deleting of the test data file, as shown in FIG. 2. That is, the third test-error result is defined as a state, in which the third test command is executed but it is not able to achieve control of cutting, pasting, copying and deleting of the test data file.

And then, in a step S15, the steps S12, S13 and S14 are repeated according to the default test condition defined in the step S11, and test results from each of the test steps S12 to S14 are recorded, and all test results are output when the default test condition has been reached. Moreover, the default test condition may also be used to stop the step S15 so that the whole read/write test method for the handheld electronic product is terminated. That is, the default test condition is defined for repeating the test method until the default duration or number of times is reached. In an embodiment of the present invention, the test duration according to the present test condition may be 8 hours. Further, the test results are output when the default test condition has been reached, allowing the test operator to analyze the data write/read state between the handheld electronic product and the storage device according to the test results.

FIG. 2 is a flowchart showing the steps included in the method according to a second embodiment of the present invention. As shown, compared with the first embodiment, the second embodiment further includes the steps S21, S22, S23 and S24. Whenever the step S21, S22 or S23 occurs, at least one of the steps S12, S13 and S14 is stopped, and the first test-error result, the second test-error result, or the third test-error result corresponding to the step S21, S22 and S23, respectively, is output in the step S24. Alternatively, the first test-error result, the second test-error result, and the third test-error result are provided for use in the step S15, so that a final test result containing the first, the second and the third test-error results is output.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A read/write test method for handheld electronic product, the handheld electronic product being connected to a storage device and being equipped with an open platform having a data read/write test program installed thereon; the method comprising the steps of:
(a) defining a default test condition;
(b) causing the data read/write test program to send out a first test command, so that a test data file is written into the storage device;
(c) causing the data read/write test program to send out a second test command when it is confirmed the test data file is present in the storage device, so as to execute control of closing and opening of the test data file and to read the test data file;
(d) causing the data read/write test program to send out a third test command when it is confirmed the test data file has been successfully read, so as to sequentially execute control of cutting, pasting, copying and deleting of the test data file; and
(e) repeating steps (b) to (d) according to the default test condition, and recording test results from each of the steps (b) to (d), and outputting the test results when the default test condition has been reached.

2. The read/write test method for handheld electronic product as claimed in claim 1, wherein the step (b) further includes a step (f), in which a first test-error result is generated when it is confirmed the test data file could not be written into the storage device.

3. The read/write test method for handheld electronic product as claimed in claim 1, wherein the step (b) further includes the steps of creating a test data folder in the storage device and writing the test data file into the test data folder.

4. The read/write test method for handheld electronic product as claimed in claim 2, wherein the step (c) further includes a step (g), in which a second test-error result is generated when it is confirmed the second test command fails to execute control of closing, opening or reading of the test data file.

5. The read/write test method for handheld electronic product as claimed in claim 4, wherein the step (d) further includes a step (h), in which a third test-error result is generated when it is confirmed the third test command fails to execute control of cutting, pasting, copying and deleting of the test data file.

6. The read/write test method for handheld electronic product as claimed in claim 5, further comprising the step of outputting a test result containing the first test-error result, the second test-error result and the third test-error result.

7. The read/write test method for handheld electronic product as claimed in claim 5, further comprising the steps of stopping at least one of the steps (b) to (e) when the step (f), (g) or (h) occurs, and outputting the first test-error result, the second test-error result and the third test-error result corresponding to the steps (f) to (h), respectively.

8. The read/write test method for handheld electronic product as claimed in claim 1, wherein the default test condition is to repeat the steps (b) to (d) for a preset duration or number of times.

9. The read/write test method for handheld electronic product as claimed in claim 8, wherein the preset duration is 8 hours.

10. The read/write test method for handheld electronic product as claimed in claim 1, wherein the open platform is an Android platform.

11. The read/write test method for handheld electronic product as claimed in claim 1, wherein the data read/write test program performs data transmission with a memory card serving as the storage device via a memory card slot to be tested on the handheld electronic product.
